(19) United States
(12) Patent Application Publication
(10) Pub. No.: US 2021/0097987 A1
(43) Pub. Date: Apr. 1, 2021

(54) DEVICE, METHOD, AND PROGRAM PRODUCT FOR DETECTING MULTIPLE UTTERANCES

(71) Applicant: LENOVO (Singapore) PTE. LTD., New Tech Park (SG)

(72) Inventors: Robert James Kapinos, Durham, NC (US); Russell Speight VanBlon, Raleigh, NC (US); Robert James Norton, JR., Raleigh, NC (US); Scott Wentao Li, Cary, NC (US)

(21) Appl. No.: 16/589,746

(22) Filed: Oct. 1, 2019

(51) Int. Cl. G10L 15/22; G10L 25/15; G10L 25/21; G10L 25/48; G06F 3/16

(52) U.S. Cl. CPC G10L 15/22; G10L 25/15; G10L 2015/223; G10L 25/48; G06F 3/167; G10L 25/21

(57) ABSTRACT

Devices, methods, and program products are disclosed for detecting multiple utterances. One device includes a component. The component is configured to operate with multiple predetermined utterances. The component is configured to detect a predetermined utterance of the multiple predetermined utterances in an audio input in any operational state of the device. The component is configured to store information indicating successful detections of the predetermined utterance, unsuccessful detections of the predetermined utterance, or a combination thereof. The component is configured to transmit the information while the device is in a regular-power operational state.

### FIELD

The subject matter disclosed herein relates to audio input devices and more particularly relates to detecting multiple utterances by the audio input device.

### BACKGROUND

### Description of the Related Art

Information handling devices, such as desktop computers, laptop computers, tablet computers, smart phones, optical head-mounted display units, smart watches, televisions, streaming devices, etc., are ubiquitous in society. These information handling devices may be used for detecting audio input. The audio input may be used to perform one or more actions.

### BRIEF SUMMARY

A device for detecting multiple utterances is disclosed. A method and computer program product also perform the functions of the device. In one embodiment, the device includes a component. The component, in some embodiments, is configured to operate with a plurality of predetermined utterances. The component, in various embodiments, is configured to detect a predetermined utterance of the plurality of predetermined utterances in an audio input in any operational state of the device. The component, in certain embodiments, is configured to store information indicating successful detections of the predetermined utterance, unsuccessful detections of the predetermined utterance, or a combination thereof. The component, in one embodiment, is configured to transmit the information while the device is in a regular-power operational state.

In some embodiments, the component is configured to, in response to the audio input including one or more predetermined utterances of the plurality of predetermined utterances, transition the device from a low-power operational state to the regular-power operational state. In one embodiment, the component executes code to detect the predetermined utterance in the audio input in any operational state of the device and to store the information indicating the successful detections of the predetermined utterance, the unsuccessful detections of the predetermined utterance, or the combination thereof. In various embodiments, the component executes code to transition the device from a low-power operational state to the regular-power operational state. In some embodiments, the component is configured to change predetermined utterances of the plurality of predetermined utterances over a period of time.

A method for detecting multiple utterances, in one embodiment, includes programming a component to detect a plurality of predetermined utterances in an audio input in any operational state of a device including the component. In certain embodiments, the method includes storing information indicating successful detections of a predetermined utterance of the plurality of predetermined utterances, unsuccessful detections of the predetermined utterance, or a combination thereof. In some embodiments, the method includes transmitting the information while the device is in a regular-power operational state.

In some embodiments, the method includes, in response to the audio input including one or more predetermined utterances of the plurality of predetermined utterances, transitioning the device from a low-power operational state to the regular-power operational state. In various embodiments, the component does not store audio input corresponding to the predetermined utterance. In one embodiment, the component does not transmit audio input corresponding to the predetermined utterance. In some embodiments, the information includes a running total of a number of times the predetermined utterance is successfully detected. In certain embodiments, the successful detections of the predetermined utterance include fully successful detections of the predetermined utterance and near-successful detections of the predetermined utterance.

In some embodiments, the method includes storing timestamps corresponding to the fully successful detections of the predetermined utterance and the near-successful detections of the predetermined utterance. In various embodiments, the audio input including the predetermined utterance is not transferred out of the component. In certain embodiments, the method includes changing predetermined utterances of the plurality of predetermined utterances over a period of time.

In one embodiment, a program product includes a component of a device. The component, in certain embodiments, is configured to operate the component with a plurality of predetermined utterances. The component, in various embodiments, is configured to detect a predetermined utterance of the plurality of predetermined utterances in an audio input in any operational state of the device. The component, in some embodiments, is configured to store information indicating successful detections of the predetermined utterance, unsuccessful detections of the predetermined utterance, or a combination thereof. The component, in certain embodiments, is configured to transmit the information while the device is in a regular-power operational state.

In certain embodiments, the component is configured to, in response to the audio input including one or more predetermined utterances of the plurality of predetermined utterances, transition the device from a low-power operational state to the regular-power operational state. In one embodiment, the component does not store audio input corresponding to the predetermined utterance. In certain embodiments, the component does not transmit the audio input corresponding to the predetermined utterance.

In various embodiments, the audio input including the predetermined utterance is not transferred out of the component. In certain embodiments, the component is configured to change predetermined utterances of the plurality of predetermined utterances over a period of time.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for detecting multiple utterances;

FIG. 2 is a schematic block diagram illustrating one embodiment of an apparatus including an information handling device;

FIG. 3 is a schematic block diagram illustrating one embodiment of an apparatus including a privacy learning module;

FIG. 4 is a schematic block diagram illustrating another embodiment of an apparatus including a privacy learning module;

FIG. 5 is a schematic flow chart diagram illustrating an embodiment of a method for detecting multiple utterances; and

FIG. 6 is a schematic flow chart diagram illustrating another embodiment of a method for detecting multiple utterances.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification have been labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

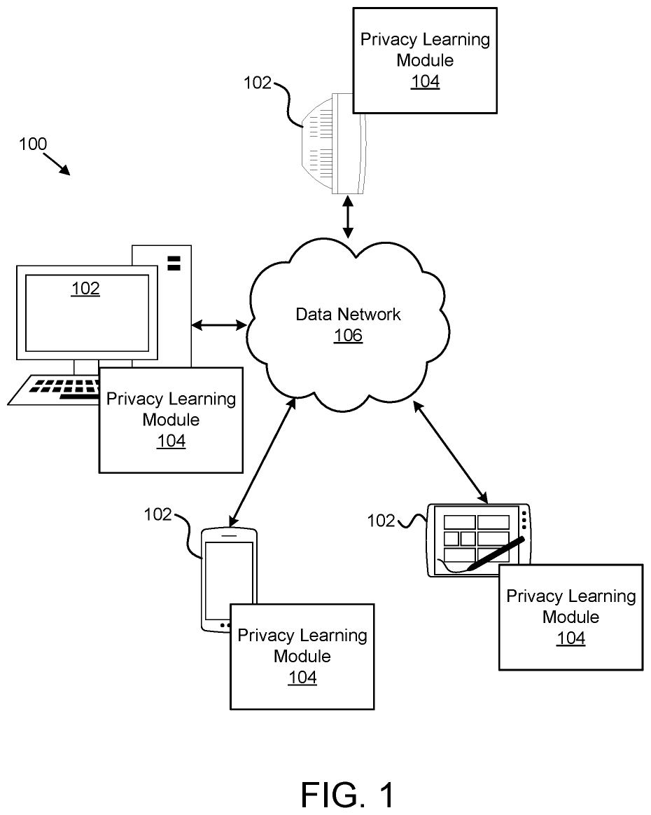

FIG. 1 depicts one embodiment of a system 100 for detecting multiple utterances. In one embodiment, the system 100 includes information handling devices 102, privacy learning modules 104, and data networks 106. Even though a specific number of information handling devices 102, privacy learning modules 104, and data networks 106 are depicted in FIG. 1, one of skill in the art will recognize that any number of information handling devices 102, privacy learning modules 104, and data networks 106 may be included in the system 100.

In one embodiment, the information handling devices 102 include computing devices, such as desktop computers, laptop computers, personal digital assistants (PDAs), tablet computers, smart phones, cellular phones, smart televisions (e.g., televisions connected to the Internet), set-top boxes, game consoles, security systems (including security cameras), vehicle on-board computers, network devices (e.g., routers, switches, modems), streaming devices, audio input devices, audio enabled devices, voice activated devices, always listening devices, or the like. In some embodiments, the information handling devices 102 include wearable devices, such as smart watches, fitness bands, optical head-mounted displays, or the like. The information handling devices 102 may access the data network 106 directly using a network connection.

The information handling devices 102 may include an embodiment of the privacy learning module 104. In certain embodiments, the privacy learning module 104 may operate with a plurality of predetermined utterances. The privacy learning module 104 may also detect a predetermined utterance of the plurality of predetermined utterances in an audio input in any operational state of the device. The privacy learning module 104 may store information indicating successful detections of the predetermined utterance and/or unsuccessful detections of the predetermined utterance. The privacy learning module 104 may also transmit the information while the device is in a regular-power operational state. In this manner, the privacy learning module 104 may be used for detecting multiple utterances.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a WAN, a storage area network (“SAN”), a LAN, an optical fiber network, the internet, or other digital communication network. The data network 106 may include two or more networks. The data network 106 may include one or more servers, routers, switches, and/or other networking equipment. The data network 106 may also include computer readable storage media, such as a hard disk drive, an optical drive, non-volatile memory, RAM, or the like.

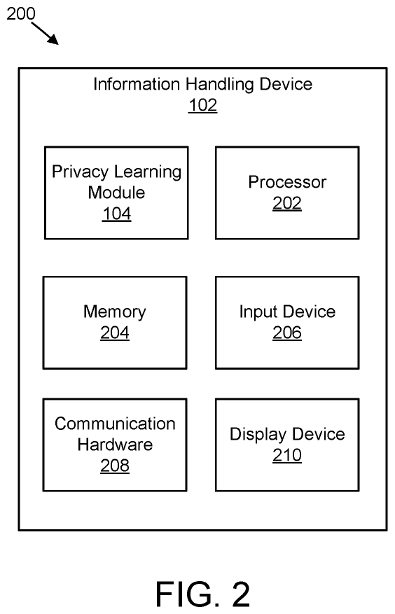

FIG. 2 depicts one embodiment of an apparatus 200 that may be used for detecting multiple utterances. The apparatus 200 includes one embodiment of the information handling device 102. Furthermore, the information handling device 102 may include the privacy learning module 104, a processor 202, a memory 204, an input device 206, communication hardware 208, and an optional display device 210. In some embodiments, the input device 206 and the display device 210 are combined into a single device, such as a touchscreen.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the privacy learning module 104, the input device 206, the communication hardware 208, and the display device 210.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media.

In some embodiments, the memory 204 stores one or more predetermined utterances. In some embodiments, the memory 204 also stores program code and related data, such as an operating system or other controller algorithms operating on the information handling device 102.

The information handling device 102 may use the privacy learning module 104 for detecting multiple utterances. As may be appreciated, the privacy learning module 104 may include computer hardware, computer software, or a combination of both computer hardware and computer software. For example, the privacy learning module 104 may include circuitry, or the processor 202, used to program a component to detect a plurality of predetermined utterances in an audio input in any operational state of a device including the component. As another example, the privacy learning module 104 may store information indicating successful detections of a predetermined utterance of the plurality of predetermined utterances and/or unsuccessful detections of the predetermined utterance. As a further example, the privacy learning module 104 may transmit the information while the device is in a regular-power operational state.

The input device 206, in one embodiment, may include any known computer input device including a touch panel, a button, a keyboard, a stylus, a microphone, an audio input device, or the like. In some embodiments, the input device 206 may be integrated with the display device 210, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel. The communication hardware 208 may facilitate communication with other devices. For example, the communication hardware 208 may enable communication via Bluetooth®, Wi-Fi, and so forth.

The display device 210, in one embodiment, may include any known electronically controllable display or display device. The display device 210 may be designed to output visual, audible, and/or haptic signals. In some embodiments, the display device 210 includes an electronic display capable of outputting visual data to a user. For example, the display device 210 may include, but is not limited to, an LCD display, an LED display, an OLED display, a projector, or similar display device capable of outputting images, text, or the like to a user. As another, non-limiting, example, the display device 210 may include a wearable display such as a smart watch, smart glasses, a heads-up display, or the like. Further, the display device 210 may be a component of a smart phone, a personal digital assistant, a television, a table computer, a notebook (laptop) computer, a personal computer, a vehicle dashboard, a streaming device, an audio input device, an audio enabled device, a voice activated device, an always listening device, or the like.

In certain embodiments, the display device 210 includes one or more speakers for producing sound. For example, the display device 210 may produce an audible alert or notification (e.g., a beep or chime). In some embodiments, the display device 210 includes one or more haptic devices for producing vibrations, motion, or other haptic feedback. For example, the display device 210 may produce haptic feedback upon performing an action. In some embodiments, the display device 210 may not include a visual display and/or the visual display may be one or more light-emitting diodes.

In some embodiments, all or portions of the display device 210 may be integrated with the input device 206. For example, the input device 206 and display device 210 may form a touchscreen or similar touch-sensitive display. In other embodiments, the display device 210 may be located near the input device 206. In certain embodiments, the display device 210 may receive instructions and/or data for output from the processor 202 and/or the privacy learning module 104.

In some embodiments, privacy of audio input received by the information handling devices 102 may be important to users. Described herein are various embodiments of information handling devices 102 that do not store audio input provided by users except audio input that closely matches preprogrammed utterances.

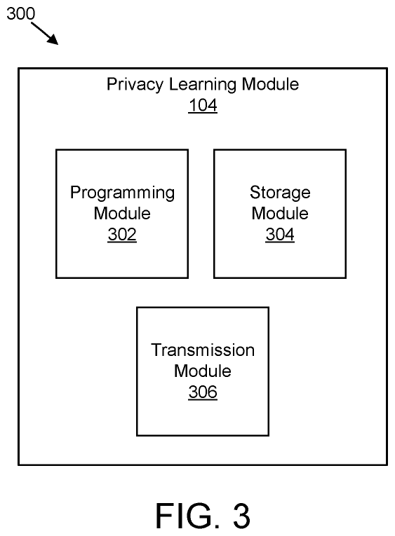

FIG. 3 depicts a schematic block diagram illustrating one embodiment of an apparatus 300 that includes one embodiment of the privacy learning module 104. Furthermore, the privacy learning module 104 includes a programming module 302, a storage module 304, and a transmission module 306.

In certain embodiments, the programming module 302 may program a component (e.g., store information in the component, store instructions in the component, provide information to the component, receive information at the component) to detect multiple predetermined utterances in an audio input in any operational state of a device including the component. The audio input may be any verbal input and/or audio input received by the device. Each predetermine utterance may be a wake word, wake phrase, a word, and/or a phrase used to wake up the device from a low-power state to a normal-power state. In various embodiments, one or more predetermined utterance of the multiple predetermined utterances may be used for training purposes (e.g., used to practice detecting the one or more predetermined utterances to develop the software used to detect the one or more predetermined utterances, the one or more predetermined utterances may be limited in duration to a maximum time period of audio input of 1, 2, 3, 5, or 10 seconds).

As may be appreciated, if a large number of components are programmed to detect a predetermined utterance used for training purposes, a large amount of data corresponding to detection of the predetermined utterance may be quickly obtained. The data may be obtained from a specific geographic area (e.g., country, region, city, state, continent), or a worldwide geographic area. The training may facilitate learning to detect the predetermined utterance with different dialects, different accents, different pronunciations, different syllable emphasis, idiom detection, language detection, and so forth. The component described herein may be a lower power computer chip (e.g., hardware-based wake word spotter, codec chip) configured to detect one or more predetermined utterances. For example, the component may have multiple wake word slots in which each wake word slot is configured to store a predetermined utterance.

In some embodiment, the component executes code to detect a predetermined utterance in audio input in any operational state (e.g., low-power state, normal-power state, regular-power state) of the device and to store information indicating successful detections of the predetermined utterance and/or unsuccessful detections of the predetermined utterance. As used herein, a low-power state may be a state of a device in which the device is not powered to perform all functions of the device (e.g., general purpose CPU and/or general purpose RAM are not powered) and/or a state of the device in which an audio input, an audio input processor, and a small amount of memory are powered (e.g., these may all be part of a single computer chip that is the only part of the device that is powered) while the rest of the device is not operationally powered. In contrast, a normal-power state and/or a regular-power state may be a state of the device in which the device is power to perform all functions of the device, including powering a general purpose CPU and general purpose RAM. The component may detect the predetermined utterances using only hardware processing (e.g., not natural language processing, not software processing).

In certain embodiments, the component executes code to transition the device from a low-power operational state to the regular-power operational state (e.g., in response to the audio input matching a predetermined utterance configured as an active wake word—not for training predetermined utterances). In various embodiments, a component does not store audio input corresponding to a predetermined utterance. For example, the component may actively process audio input to attempt to match the audio input with a predetermined utterance (e.g., wake word), but the component does not store the audio input after actively processing the audio input. Furthermore, after the predetermined utterance is detected in the audio input, the component does not store words adjacent to the predetermined utterance and/or any audio input except possibly the predetermined utterance.

In various embodiments, a component does not transmit audio input corresponding to a predetermined utterance. In certain embodiments, a component may not store audio input corresponding to a predetermined utterance and/or may not transmit audio input corresponding to the predetermined utterance. For example, if the predetermined utterance is “boxcar” and the audio input is “boxcar play some music,” the component may not store any words except the word “boxcar” and/or may not transmit the phrase “play some music” outside of the component. In other words, the audio input that includes the predetermined utterance is not transferred out of the component. Accordingly, privacy of words spoken by a user is protected because nothing outside of the component has access to audio input of the user except for the predetermined utterance. It should be noted that the component may be configured with multiple predetermined utterances; however, the number of multiple predetermined utterances may be limited to 2, 4, 6, 8, 10, 12, 14, 16, 18, 32, 64, and/or 128 predetermined utterances. Accordingly, the limit on the number of predetermined utterances may further protect the privacy of users of the component and/or devices that include the component.

In one embodiment, the storage module 304 may store information indicating successful detections of a predetermined utterance of the plurality of predetermined utterances and/or unsuccessful detections of the predetermined utterance. In certain embodiments, the information includes a running total of a number of times the predetermined utterance is successfully detected. In various embodiments, successful detections of the predetermined utterance may include fully successful detections (e.g., exact matches) of the predetermined utterance and/or near-successful detections of the predetermined utterance (e.g., close matches). For example, if the predetermine utterance is “robot” and the audio input detected by the privacy learning module 104 is “robot,” the privacy learning module 104 may detect that this audio input is a fully successful detection of the predetermined utterance. As another example, if the predetermined utterance is “robot” and the audio input detected by the privacy learning module 104 is “rabbit,” the privacy learning module 104 may detect that this audio input is a near-successful detection of the predetermined utterance.

In certain embodiments, the storage module 304 may store timestamps corresponding to fully successful detections of the predetermined utterance and/or near-successful detections of the predetermined utterance. The timestamps may be used to indicate a date, a time, and/or a frequency of the fully successful detections and/or the near successful detections. In various embodiments, the transmission module 306 may transmit the information while the device is in a regular-power operational state. For example, the component may store information about successful and/or unsuccessful detections of one or more predetermined utterances that may occur while the component is in a low-power operational state and/or a regular-power operational state, then, while the component is in the regular-power operational state, the component may transmit the information to a computer outside of the device.

In certain embodiments, the privacy learning module 104 may include a component configured to operate with a plurality of predetermined utterances and/or detect a predetermined utterance of the plurality of predetermined utterances in an audio input in any operational state of the device (e.g., regardless of whether the device is in a low-power state or in a normal or regular power state).

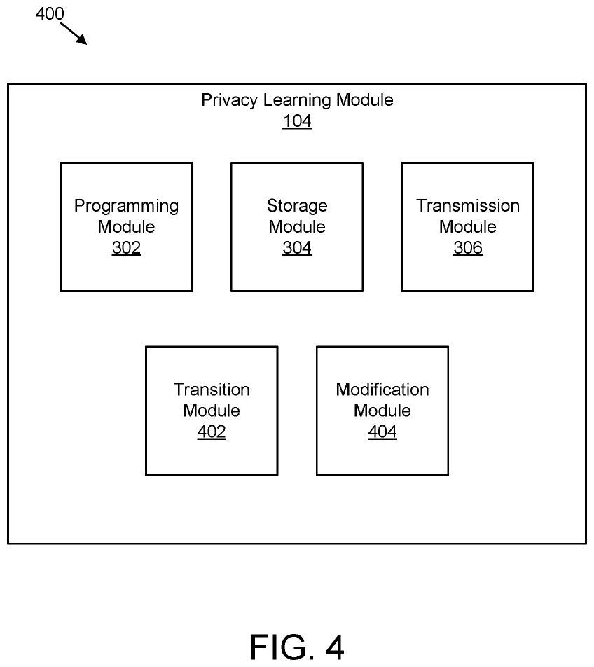

FIG. 4 is a schematic block diagram illustrating another embodiment of an apparatus 400 that includes one embodiment of the privacy learning module 104. Furthermore, the privacy learning module 104 includes one embodiment of the programming module 302, the storage module 304, and the transmission module 306, that may be substantially similar to the programming module 302, the storage module 304, and the transmission module 306 described in relation to FIG. 3. The apparatus 400 includes a transition module 402 and a modification module 404.

The transition module 402 may, in response to the audio input including one or more predetermined utterances of the plurality of predetermined utterances, transitioning the device from a low-power operational state to the regular-power operational state. This may occur if the one or more predetermine utterances are configured as utterances that enable transition of the device from the low-power operational state to the regular-power operational state (e.g., live wake words, live wake phrases, active wake words, active wake phrases). In contrast, certain predetermined utterances of the plurality of predetermined utterances do not cause transition the device from the low-power operational state to the regular-power operational state, but instead, leave the device in the operational state the device was in at the time that the device detected those certain predetermined utterances. These certain predetermined utterances may be training utterances and/or learning utterances used to improve code used to detect those predetermined utterances.

The modification module 404 may change predetermined utterances of the plurality of predetermined utterances over a period of time. For example, the modification module 404 may rotate through a set of configured predetermined utterances over the period of time. As another example, the modification module 404 may be programmed to use one or more predetermined utterances for a set period of time, then programmed to transition to different predetermined utterances for a following period of time.

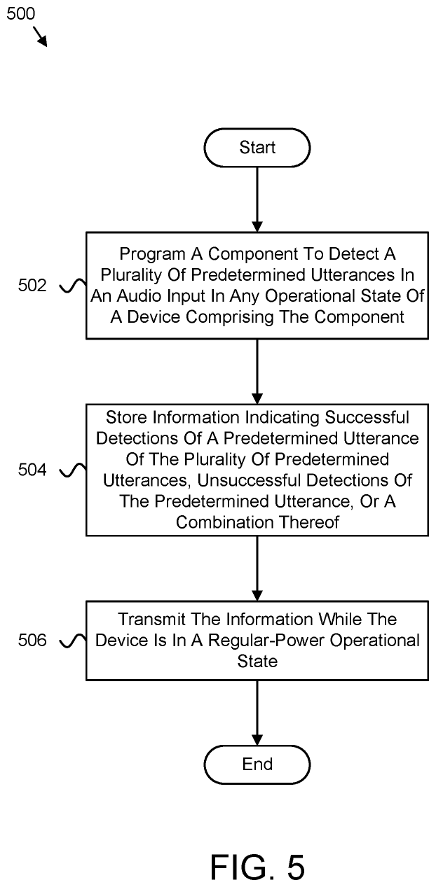

FIG. 5 is a schematic flow chart diagram illustrating an embodiment of a method 500 for detecting multiple utterances. In some embodiments, the method 500 is performed by an apparatus, such as the information handling device 102. In other embodiments, the method 500 may be performed by a module, such as the privacy learning module 104. In certain embodiments, the method 500 may be performed by a processor executing program code, for example, a microcontroller, a microprocessor, a CPU, a GPU, an auxiliary processing unit, a FPGA, or the like.

The method 500 may include programming 502 a component to detect a plurality of predetermined utterances in an audio input in any operational state of a device comprising the component. In certain embodiments, the programming module 302 may program 502 the component to detect the plurality of predetermined utterances in the audio input in any operational state of the device comprising the component. In some embodiments, the audio input including the predetermined utterance is not transferred out of the component.

The method 500 may include storing 504 information indicating successful detections of a predetermined utterance of the plurality of predetermined utterances, unsuccessful detections of the predetermined utterance, or a combination thereof. In some embodiments, the storage module 304 may store 504 the information indicating successful detections of the predetermined utterance of the plurality of predetermined utterances, unsuccessful detections of the predetermined utterance, or the combination thereof. In various embodiments, the information includes a running total of a number of times the predetermined utterance is successfully detected. In certain embodiments, the successful detections of the predetermined utterance include fully successful detections of the predetermined utterance and near-successful detections of the predetermined utterance. In some embodiments, the method 500 included storing timestamps corresponding to the fully successful detections of the predetermined utterance and the near-successful detections of the predetermined utterance.

The method 500 may include transmitting 506 the information while the device is in a regular-power operational state, and the method 500 may end. In some embodiments, the transmission module 306 may transmit 506 the information while the device is in the regular-power operational state.

In certain embodiments, the method 500 may, in response to the audio input including one or more predetermined utterances of the plurality of predetermined utterances, transition the device from a low-power operational state to the regular-power operational state. In various embodiments, the component does not store audio input corresponding to the predetermined utterance. In some embodiments, the component does not transmit audio input corresponding to the predetermined utterance. In certain embodiments, the method 500 includes changing predetermined utterances of the plurality of predetermined utterances over a period of time.

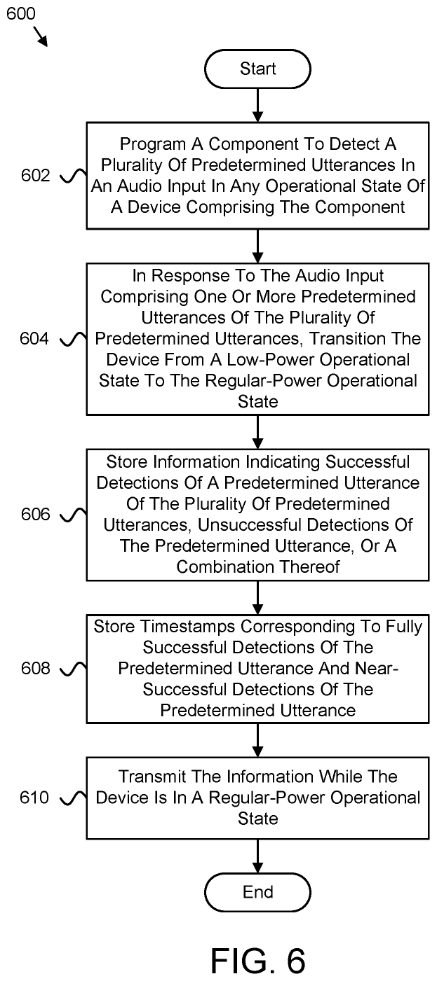

FIG. 6 is a schematic flow chart diagram illustrating another embodiment of a method 600 for detecting multiple utterances. In some embodiments, the method 600 is performed by an apparatus, such as the information handling device 102. In other embodiments, the method 600 may be performed by a module, such as the privacy learning module 104. In certain embodiments, the method 600 may be performed by a processor executing program code, for example, a microcontroller, a microprocessor, a CPU, a GPU, an auxiliary processing unit, a FPGA, or the like.

The method 600 may include programming 602 a component to detect a plurality of predetermined utterances in an audio input in any operational state of a device comprising the component. In certain embodiments, the programming module 302 may program 602 the component to detect the plurality of predetermined utterances in the audio input in any operational state of the device comprising the component. In some embodiments, the audio input including the predetermined utterance is not transferred out of the component.

The method 600 may, in response to the audio input including one or more predetermined utterances of the plurality of predetermined utterances, transition 604 the device from a low-power operational state to the regular-power operational state. In various embodiments, the privacy learning module 104 may, in response to the audio input including one or more predetermined utterances of the plurality of predetermined utterances, transition 604 the device from the low-power operational state to the regular-power operational state.

The method 600 may include storing 606 information indicating successful detections of a predetermined utterance of the plurality of predetermined utterances, unsuccessful detections of the predetermined utterance, or a combination thereof. In some embodiments, the storage module 304 may store 606 the information indicating successful detections of the predetermined utterance of the plurality of predetermined utterances, unsuccessful detections of the predetermined utterance, or the combination thereof. In various embodiments, the information includes a running total of a number of times the predetermined utterance is successfully detected. In certain embodiments, the successful detections of the predetermined utterance include fully successful detections of the predetermined utterance and near-successful detections of the predetermined utterance.

In some embodiments, the method 600 included storing 608 timestamps corresponding to fully successful detections of the predetermined utterance and near-successful detections of the predetermined utterance. In various embodiments, the privacy learning module 104 may store 608 timestamps corresponding to the fully successful detections of the predetermined utterance and the near-successful detections of the predetermined utterance.

The method 600 may include transmitting 610 the information while the device is in a regular-power operational state, and the method 600 may end. In some embodiments, the transmission module 306 may transmit 610 the information while the device is in the regular-power operational state.

In various embodiments, the component does not store audio input corresponding to the predetermined utterance. In some embodiments, the component does not transmit audio input corresponding to the predetermined utterance. In certain embodiments, the method 600 includes changing predetermined utterances of the plurality of predetermined utterances over a period of time.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A device comprising:
a component configured to:
operate with a plurality of predetermined utterances;
detect a predetermined utterance of the plurality of predetermined utterances in an audio input in any operational state of the device;
store information indicating successful detections of the predetermined utterance, unsuccessful detections of the predetermined utterance, or a combination thereof; and
transmit the information while the device is in a regular-power operational state.

2. The device of claim 1, wherein the component is configured to, in response to the audio input comprising one or more predetermined utterances of the plurality of predetermined utterances, transition the device from a low-power operational state to the regular-power operational state.

3. The device of claim 1, wherein the component executes code to detect the predetermined utterance in the audio input in any operational state of the device and to store the information indicating the successful detections of the predetermined utterance, the unsuccessful detections of the predetermined utterance, or the combination thereof.

4. The device of claim 1, wherein the component executes code to transition the device from a low-power operational state to the regular-power operational state.

5. The device of claim 1, wherein the component is configured to change predetermined utterances of the plurality of predetermined utterances over a period of time.

6. A method comprising:
programming a component to detect a plurality of predetermined utterances in an audio input in any operational state of a device comprising the component;
storing information indicating successful detections of a predetermined utterance of the plurality of predetermined utterances, unsuccessful detections of the predetermined utterance, or a combination thereof; and
transmitting the information while the device is in a regular-power operational state.

7. The method of claim 6, further comprising, in response to the audio input comprising one or more predetermined utterances of the plurality of predetermined utterances, transitioning the device from a low-power operational state to the regular-power operational state.

8. The method of claim 6, wherein the component does not store audio input corresponding to the predetermined utterance.

9. The method of claim 6, wherein the component does not transmit audio input corresponding to the predetermined utterance.

10. The method of claim 6, wherein the information comprises a running total of a number of times the predetermined utterance is successfully detected.

11. The method of claim 6, wherein the successful detections of the predetermined utterance comprise fully successful detections of the predetermined utterance and near-successful detections of the predetermined utterance.

12. The method of claim 11, further comprising storing timestamps corresponding to the fully successful detections of the predetermined utterance and the near-successful detections of the predetermined utterance.

13. The method of claim 6, wherein the audio input comprising the predetermined utterance is not transferred out of the component.

14. The method of claim 6, further comprising changing predetermined utterances of the plurality of predetermined utterances over a period of time.

15. A program product comprising a component of a device, the component configured to:
operate the component with a plurality of predetermined utterances;
detect a predetermined utterance of the plurality of predetermined utterances in an audio input in any operational state of the device;
store information indicating successful detections of the predetermined utterance, unsuccessful detections of the predetermined utterance, or a combination thereof; and
transmit the information while the device is in a regular-power operational state.

16. The program product of claim 15, wherein the component is configured to, in response to the audio input comprising one or more predetermined utterances of the plurality of predetermined utterances, transition the device from a low-power operational state to the regular-power operational state.

17. The program product of claim 15, wherein the component does not store audio input corresponding to the predetermined utterance.

18. The program product of claim 15, wherein the component does not transmit the audio input corresponding to the predetermined utterance.

19. The program product of claim 15, wherein the audio input comprising the predetermined utterance is not transferred out of the component.

20. The program product of claim 15, wherein the component is configured to change predetermined utterances of the plurality of predetermined utterances over a period of time.
